(19) United States
(12) Patent Application Publication
(10) Pub. No.: US 2009/0021389 A1
(43) Pub. Date: Jan. 22, 2009

(54) Traffic Control Apparatus

(76) Inventor: Robert Nelson Entrup, South Fork, CO (US)

Correspondence Address: Roger A. Jackson, Esq., Suite G-7, 1115 Grant Street, Denver, CO, 80203-2399, US

(21) Appl. No.: 11/779,279

(22) Filed: Jul. 18, 2007

(51) Int. Cl. G08B 5/02; G09F 7/00

(52) U.S. Cl. 340/815.87; 40/612

(57) ABSTRACT

The present invention is a traffic control apparatus to further control a flow of traffic. The traffic control apparatus comprises a base structure which supports a figurine, wherein the figurine is operational to help solicit attention from the flow of traffic. The traffic control apparatus further comprises a method for creating a perceptible safety warning using a combination of the base structure and the figurine.

### TECHNICAL FIELD

The present invention generally relates to an apparatus for traffic control and safety. More particularly, the present invention uses a manually operated remote control to engage a variety of mechanisms to emulate a roadside flagger to control the flow of traffic near road construction or other similar sites, thus decreasing both the need for personnel to perform monotonous tasks, leading to boredom and distraction from the task at hand, and reducing the potential for human injury due to proximity to traffic.

### BACKGROUND OF INVENTION

Traffic control is useful for a variety of traffic situations, such as road construction or vehicular accidents. Oftentimes in such situations, it is necessary to shut down one or more lanes of a roadway. A flagman is frequently utilized to accomplish this task, especially when conditions are in a state of flux. Depending on the size and state of conditions, several flagmen may be used in conjunction with each other. A flagman will generally use a sign to convey their message to oncoming motorists. Usually, the sign has the ability to be rotated and thus can typically carry two messages for more precise control of motorists, such as ‘stop’ on one side and ‘slow’ on the reverse. If two or more flagmen are working together in a traffic control situation, they are generally in close communication with each other, either directly or through radio transmission. Flagmen serve two main purposes: to convey up to the second information to motorists and to significantly increase the conspicuousness and seriousness of the road condition situation to motorists.

To be effective, the flagman must be in plain view of oncoming traffic. Plain view is unfortunately equated to close proximity, creating a dangerous environment for both the flagman and oncoming motorists. This issue is well-recognized in the art, and in looking to the applicable prior art, has been addressed in several ways. One approach to increasing the safety of such a situation is to heighten the visibility of the sign itself. One prior example of this approach is disclosed in U.S. Pat. No. 6,204,777 to Lyons which discloses a manually held reversible sign with battery operated light emitting diode arrays that reinforce the printed words on the sign. While the Lyons' device does increase the visibility of the sign without significantly increasing its weight, the person holding the sign is still within an arm's length of the sign, and thus still extremely vulnerable to safety breaches from adjacent traffic.

To further address the issue of human safety on sites where traffic control is necessary, remotely controlled devices have been utilized. Looking to the prior art, U.S. Pat. No. 5,422,638 to Singer et al., discloses a two faced sign that can be remotely operated from a safe distance. However in Singer, the sign is ordinary looking with nothing to draw a motorist's attention to the need for specialized attention. Singer's device also uses a combination of three base structures which radiate outward from the main body of the sign for stability. These base structures cause Singer's device to take up a large amount of room, relative to the size of the functional sign structure, and pose a safety hazard due to their radiation outward from the actual device.

Another example of a remote device is disclosed in U.S. Pat. No. 5,959,554 to Armstrong et al. In the Armstrong et al., device, one sign can be used on its own, or two or more signs can be utilized in conjunction with a single remote handset for operation. Each sign in Armstrong et al. is comprised of one side meant to signal traffic to stop and the opposite side to signal traffic to go. Used conjunctively, two Armstrong et al. signs are designed to be in one of four operational states relative to each other: first, each sign signaling motorists to stop; second, the first sign rotated one hundred and eighty degrees to signal go with the second sign continuing to signal stop; third, the first sign returning to its original position to signal stop with the second sign remaining on the signal to stop; and finally, the second signal rotating one hundred and eighty degrees to signal motorists to go. The remote mechanism in Armstrong et al. is designed to rotate the signs through the operational states in succession. Similarly to the previous disclosure by Singer, the sign utilized by Armstrong et al. are ordinary looking, with nothing special to draw a motorist's attention to the enhanced need for caution.

Similar to Armstrong et al.'s device, U.S. Pat. No. 6,104,313 to Boyd II and U.S. Pat. No. 6,150,957 to Henz et al. disclose rotatable signs. Both Boyd II and Henz et al.'s devices also include a means of illumination of the sign itself. Once again, the units in Boyd II and Henz et al. being mere signs do not adequately draw motorist's attention to the devices.

Another remotely controlled device for use to control the flow of traffic is a portable traffic control signal, as disclosed in U.S. Pat. No. 5,986,576 to Armstrong. Armstrong's device utilizes several of the now-familiar traffic light set up of red, amber, and green for stop, caution, and go, in a self-contained and remotely operable unit, such that each set of lights faces a different direction for use at traffic intersections. While Armstrong's device removes the need for personnel in the vicinity of the signal, it again does not convey to motorists the specialized need for attention to the traffic situation in the same manner a flagman would.

The final approach to increasing the safety of personnel in traffic control situations in the prior art is to have a human figurine of some type to call for a motorist's special attention to the traffic control situation. In U.S. Pat. No. 5,001,475 to Scovin, a human shaped figurine in the form of back-to-back traffic officers is utilized in conjunction with a set of stop and go traffic lights. Scovin's device utilizes cables to coordinate the signals, which produces a tripping hazard in an already dangerous environment. Also in Scovin, the traffic light set up is wired such that the opposing sides of the traffic light will give opposing signals, such that when one side is signaling green or go, the opposite side will be signaling red or stop. This set up, as described in Scovin, will make transitions from one signal to the next potentially hazardous, as traffic that has been given the stop signal will be transitioned directly to the go signal while oncoming traffic that had previously been given the signal to go will still be moving through the affected area.

Another such device is disclosed in U.S. Pat. No. 6,052,067 to Nuxoll. Nuxoll's device utilizes a simulated three-dimensional human head and torso attached to a sawhorse-like tubular frame with a wirelessly rotatable sign attached to an arm to display two independent messages. The tubular frame in Nuxoll's device takes up a large area in what is likely an already crowded workspace. The sign used to gain motorist's attention in Nuxoll's device is neither illuminated nor moveable, except for rotation, making the sign ordinary and easy for motorists to overlook. The full-sized human torso utilized in Nuxoll may also be disconcerting to passing motorists, drawing attention away from the sign and leading to an undesirable result.

Further in this same area, in U.S. Pat. No. 6,448,905 to Jones, a life-sized, three dimensional human figurine is utilized in conjunction with a rotatable, double-sided sign. The sign in Jones' device is illuminated around the outside and wirelessly remote controlled for rotation, but has no further motility to garner increased attention. In Jones' device, the three-dimensional nature of the figurine also creates a bulky apparatus for transport and mobility.

The prior art in the field of automated and semi-automated traffic safety devices emphasizes the need for enhanced visibility of such devices by motorists while maintaining safety in any given situation. What is needed in the field is a manually operated remote control apparatus in a two-dimensional format simulating a real person for ease of movement in conjunction with a sign that maximizes visibility of the sign to motorists through both vertical movement and illumination. Such a sign would increase the adherence of motorists to the sign's commands, maximize safety for road personnel, and reduce the number of personnel needed for traffic control for any given situation.

### SUMMARY OF INVENTION

The present invention is a traffic control apparatus to further control a flow of traffic. The traffic control apparatus comprises a base structure which supports a figurine, wherein the figurine is operational to help solicit attention from the flow of traffic. The traffic control apparatus further comprises a method for creating a perceptible safety warning using a combination of the base structure and the figurine.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a front view of a traffic control apparatus with the indicia indicating ‘STOP’;

FIG. 2 shows a front view of the traffic control apparatus with the indicia indicating ‘SLOW’ 68;

FIG. 3 shows a perspective front view of the traffic control apparatus with the indicia indicating ‘STOP’ and the pivotal arm extended through vertical movement;

FIG. 4 shows a front view of the traffic control apparatus with the indicia indicating ‘SLOW’ and the pivotal arm extended through vertical movement;

FIG. 5 shows a back view of the traffic control apparatus;

FIG. 6 shows a side view of the traffic control apparatus;

FIG. 7 shows an enlarged front view of the indicia indicating ‘STOP’;

FIG. 8 shows an enlarged back view of the telescoping pole;

FIG. 9 shows an enlarged lower back view of the traffic control apparatus;

FIG. 10 shows an enlarged lower front view of the traffic control apparatus;

FIG. 11 shows an enlarged view of the control circuitry;

FIG. 12 shows a summary schematic of the means for creating a perceptible safety warning;

FIG. 13 shows a detailed drawing of the remote control;

FIG. 14 shows a detailed schematic of the dip switch with settings found in the remote control and in the two channel receiving unit control;

FIG. 15 shows a detailed schematic of the two channel receiving unit;

FIG. 16 shows a detailed schematic of the first relay;

FIG. 17 shows a detailed schematic of the second relay;

FIG. 18 shows a detailed schematic drawing of the first actuator;

FIG. 19 shows a detailed schematic drawing of the second actuator; and

FIG. 20 shows a use drawing of the traffic control apparatus showing a user and the flow of traffic.

### REFERENCE NUMBERS IN DRAWINGS

30 Traffic control apparatus
32 Flow of traffic
34 Base structure
36 Means for base flexibility
38 Base first portion
40 Base second portion
42 Base first portion and base second portion capable of independent motion
44 Means for controlling omnidirectional movement between base first portion and base second portion
45 Spring
46 Figurine
47 Support structure
48 Figurine to solicit attention from the flow of traffic
50 Figurine sized and configured to substantially appear to be a highway flag person or traffic safety officer
52 Pivotal arm
54 Pivotal arm adjacent to figurine
56 Plurality of elements pivotally connected to one another
58 Proximal arm portion of pivotal arm
60 Distal arm portion of pivotal arm
62 Pivotal elements sized and configured to substantially resemble a human arm
63 Telescoping pole assembly
64 Means for creating a perceptible safety warning using a combination of said base structure and said figurine
65 Pin
66 Indicia indicating ‘STOP’
67 Telescoping pole guide
68 Indicia indicating ‘SLOW’
69 Lock ring
70 Yellow strobe light adjacent to indicia indicating ‘SLOW’
71 Fastener
72 Red strobe light adjacent to indicia indicating ‘STOP’
74 Bidirectional movement of indicia
75 Rack and pinion mechanism
76 Rotational motion of indicia from gear pinion 126
77 Rack and pinion housing
78 Mechanism
80 Control circuitry
82 First actuator
83 Second actuator
84 User
86 User selected warning
88 Remote control
90 Circuitry housing
92 Power supply housing
94 Power supply
96 First relay
97 Second relay
98 Control being a two channel receiving unit
100 Antenna
102 Movement of first relay 96
104 Movement of second relay 97
106 Com for first relay 96
108 Com for second relay 97
110 Alternating movement of first relay 96
112 Alternating movement of second relay 97
114 Motor for rack and pinion for stop/slow indicia change
116 Motor for square thread rod for bidirectional movement of indicia
118 Gear drive for motor 114
120 Square thread rod for motor 114
122 Drive block for square thread rod 120
124 Gear rack
126 Gear pinion
128 Bidirectional rotational movement of motor 114 drive train
130 Reciprocating movement of gear rack 124
134 Limit switches for reciprocating movement 130
136 Gear drive for motor 116
138 Square thread rod for motor 116
140 Drive block for square thread rod 138
142 Bidirectional rotational movement of motor 116 drive train
144 Limit switches for bidirectional movement 74
146 Dip switch with exemplary settings
148 Indicator light for remote control 88
150 Button on remote control 88 for first relay 96
152 Button on remote control 88 for second relay 97
200 Switched power for first relay 96
202 Ground for first relay 96
204 Switched power for second relay 97
205 Ground for second relay 97
206 Direct positive power
208 Terminal block in electrical communication with power supply 94 (−) ground
210 Motor 114 power lead rack and pinion
212 Motor 114 power lead rack and pinion
214 Motor 116 power lead square thread
216 Motor 116 power lead square thread

### DETAILED DESCRIPTION

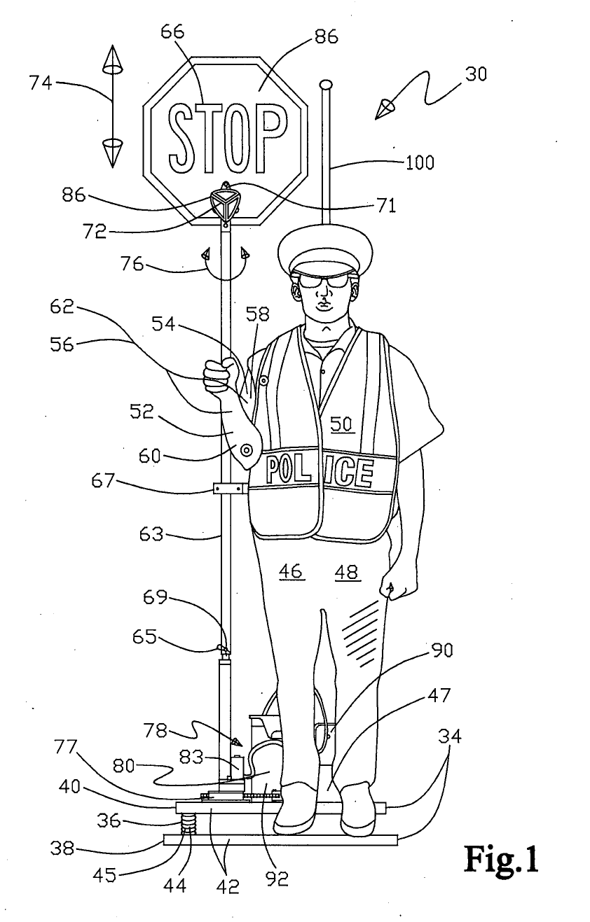

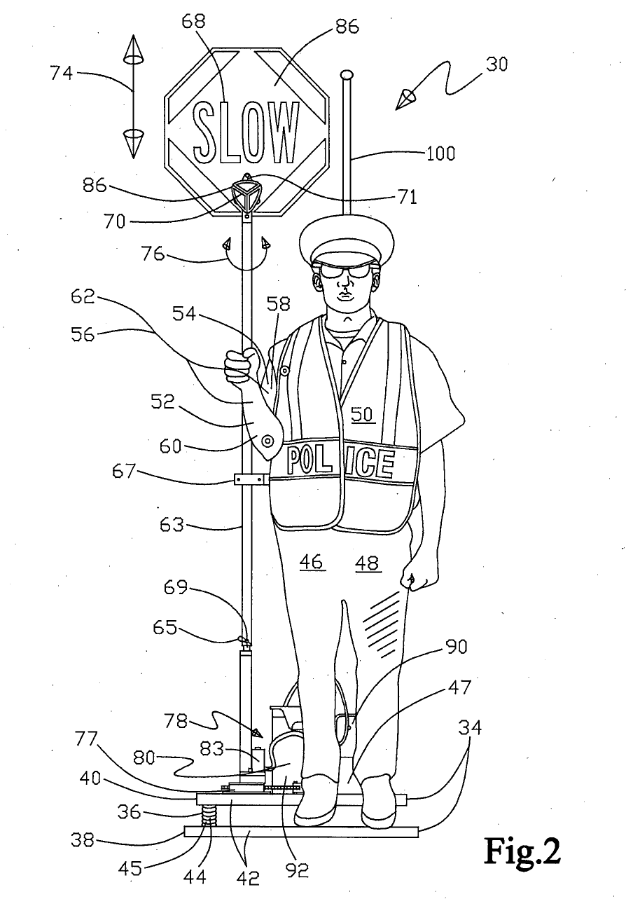

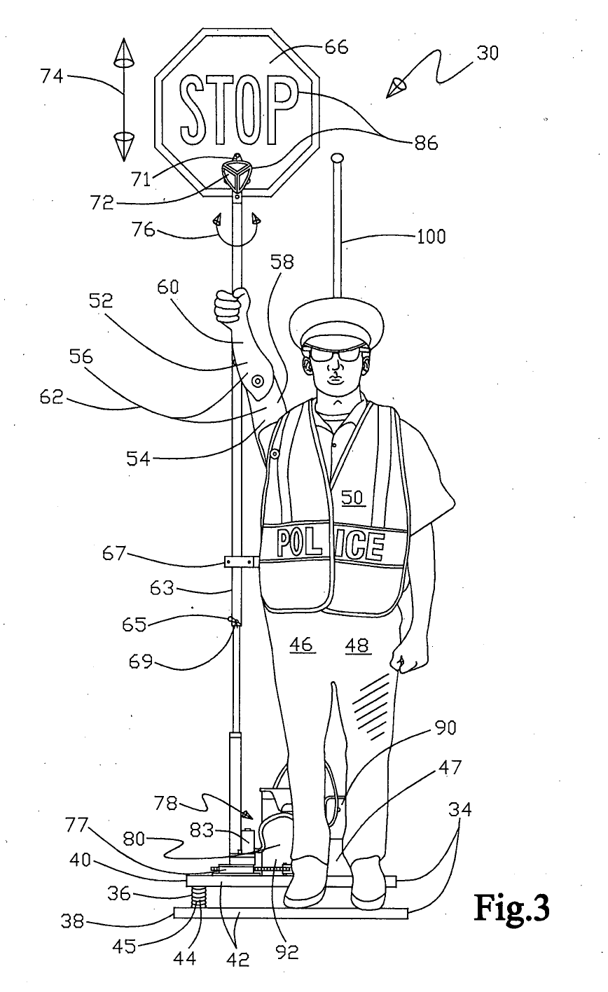

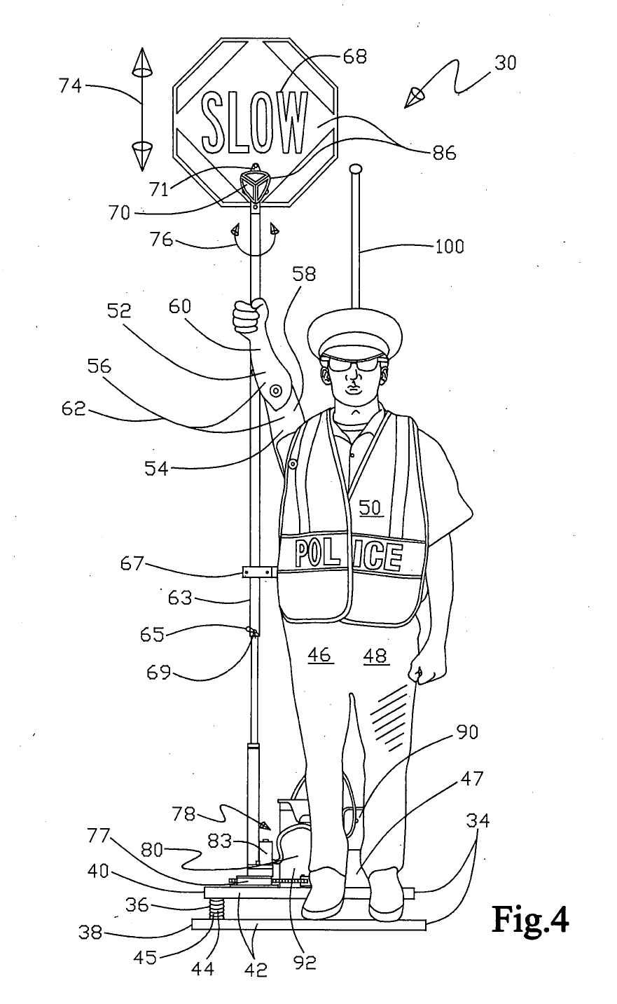

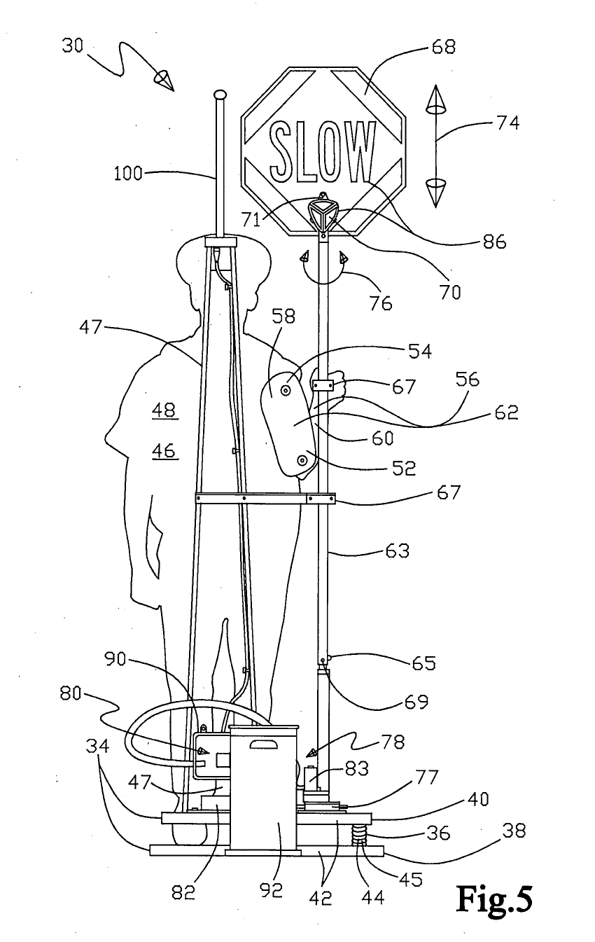

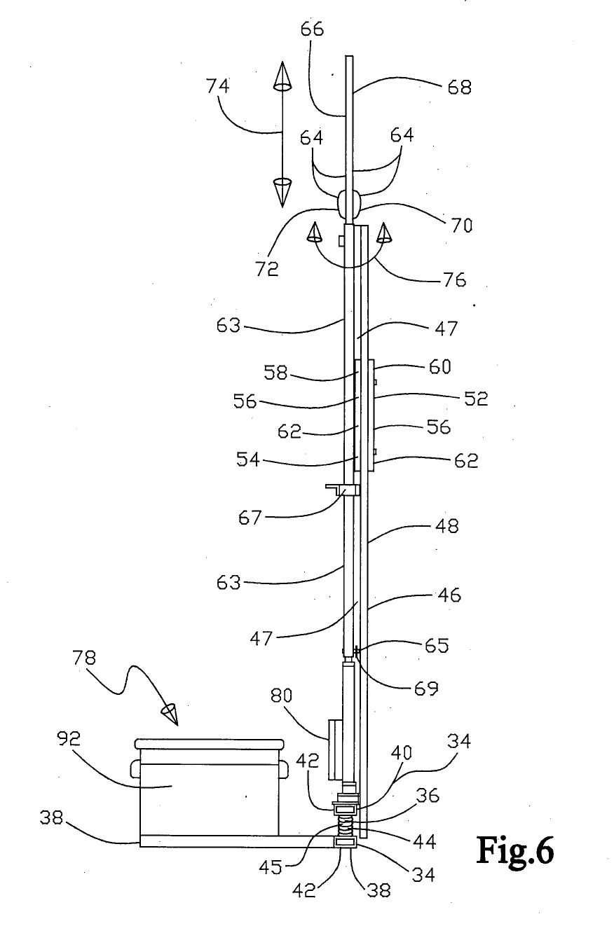

With initial reference to FIG. 1, shown is a perspective view of the traffic control apparatus 30. FIG. 1 shows the traffic control apparatus 30 with a preferred indicia indicating ‘STOP’ 66. FIG. 2 also shows a perspective view of the traffic control apparatus 30 with the preferred indicia indicating ‘SLOW’ 68. FIGS. 3 and 4 also show perspective front views of the traffic control apparatus 30 with the indicia indicating ‘STOP’ 66 or the indicia indicating ‘SLOW’ 68, respectively, and the optional pivotal arm 52 extended. FIG. 5 shows a perspective view of the traffic control apparatus 30 from the back, while FIG. 6 shows the traffic control apparatus 30 from the side.

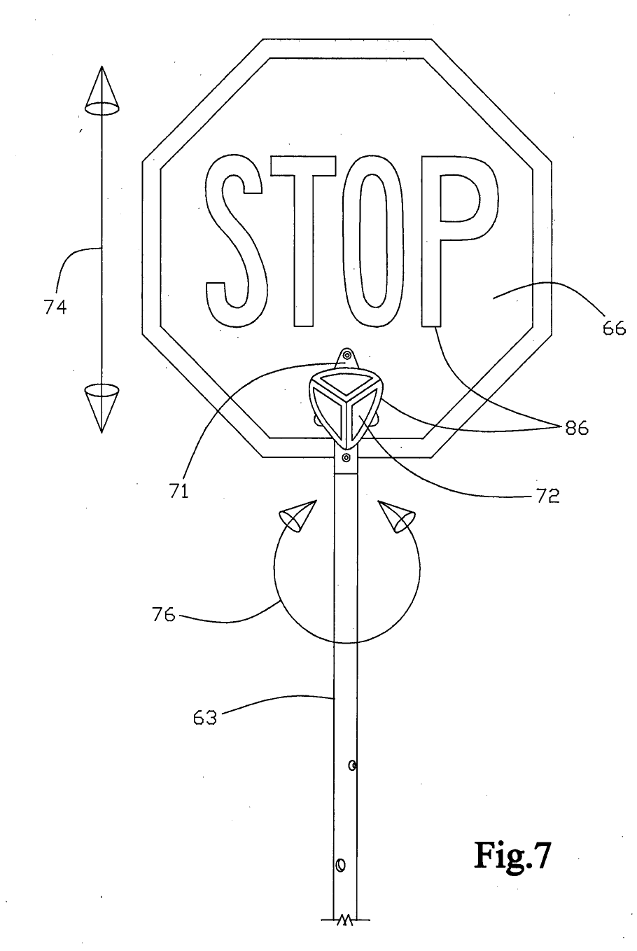

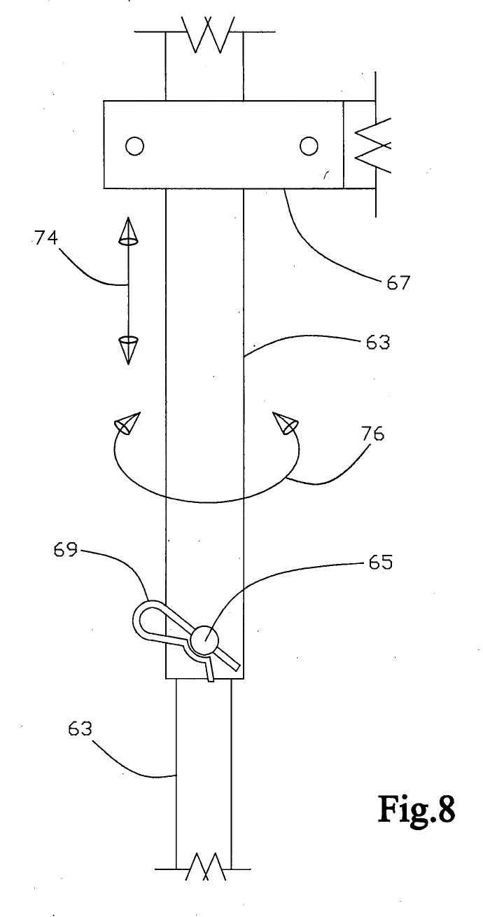

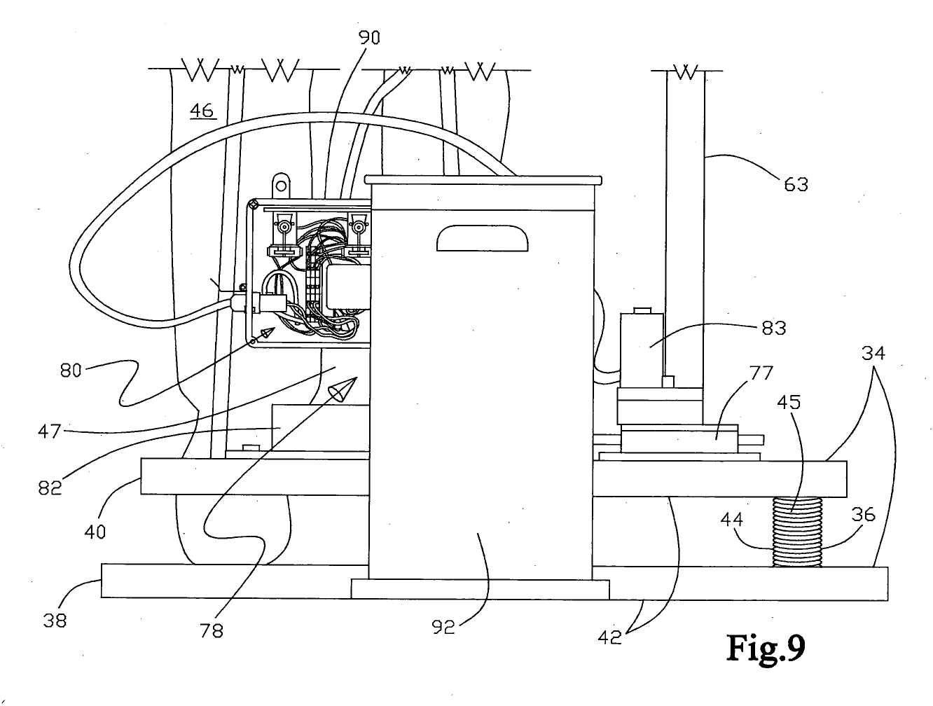

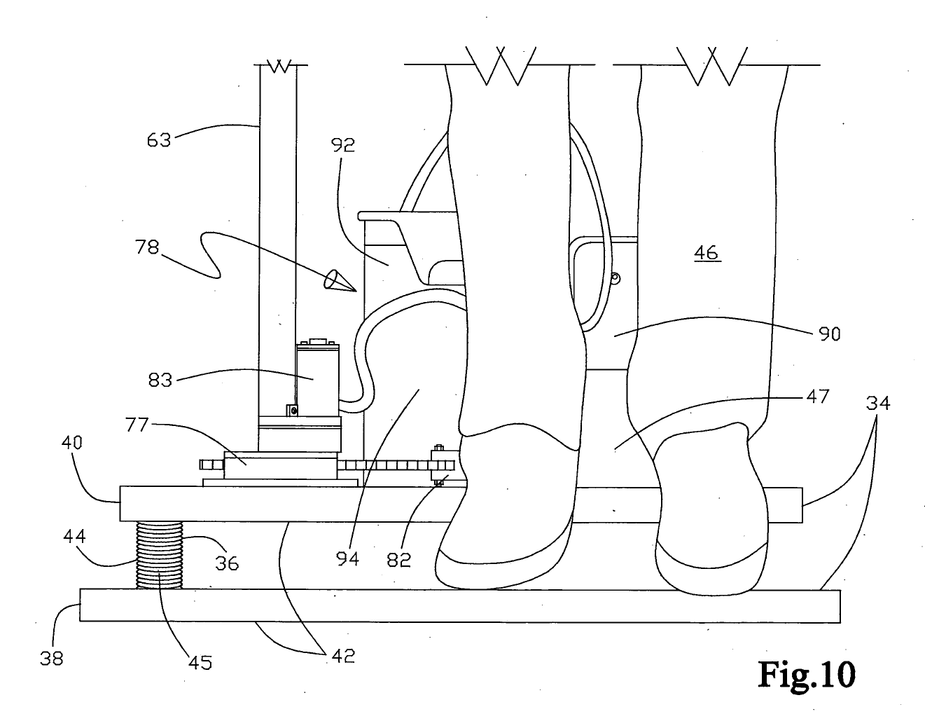

FIG. 7 shows an enlarged front view of the indicia indicating ‘STOP’ 68 as well as a portion of the telescoping pole assembly 63 and the red strobe light 72. FIG. 8 shows an enlarged front view of the telescoping pole assembly 63 including a pin 65 and lock ring 69, as well as a telescoping pole guide 67. FIG. 9 shows an enlarged lower back view of the traffic control apparatus 30, including the base structure 34 and the control circuitry 80, while FIG. 10 shows the same enlarged lower view from the front perspective.

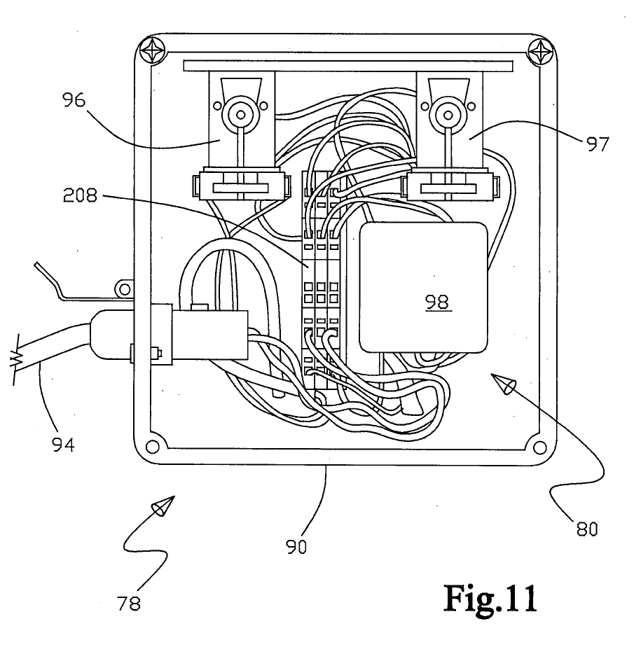

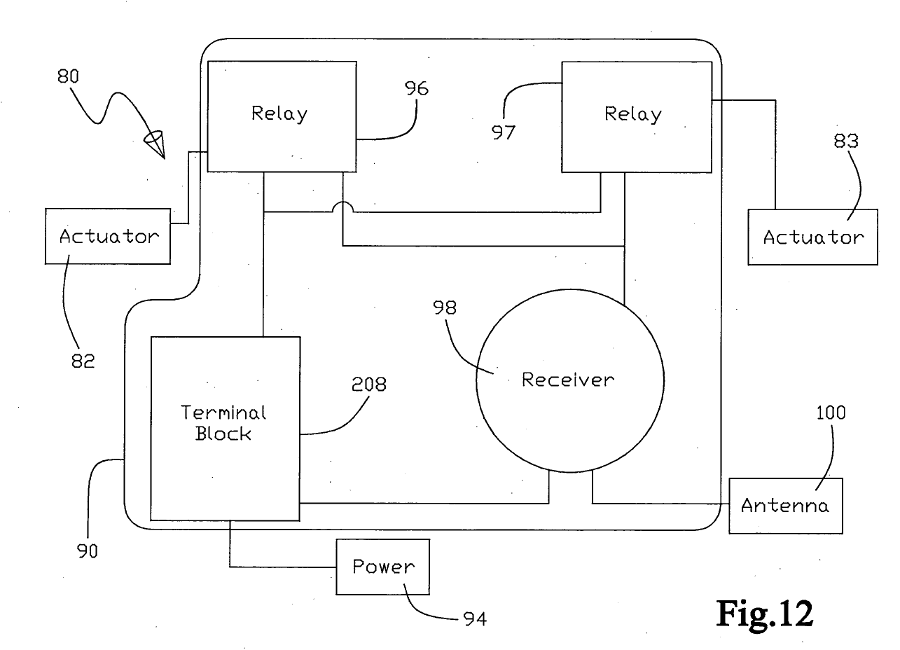

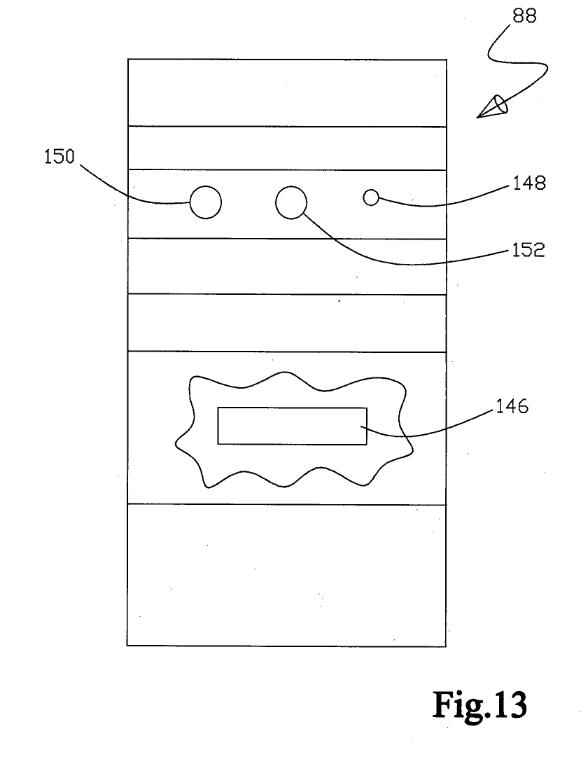

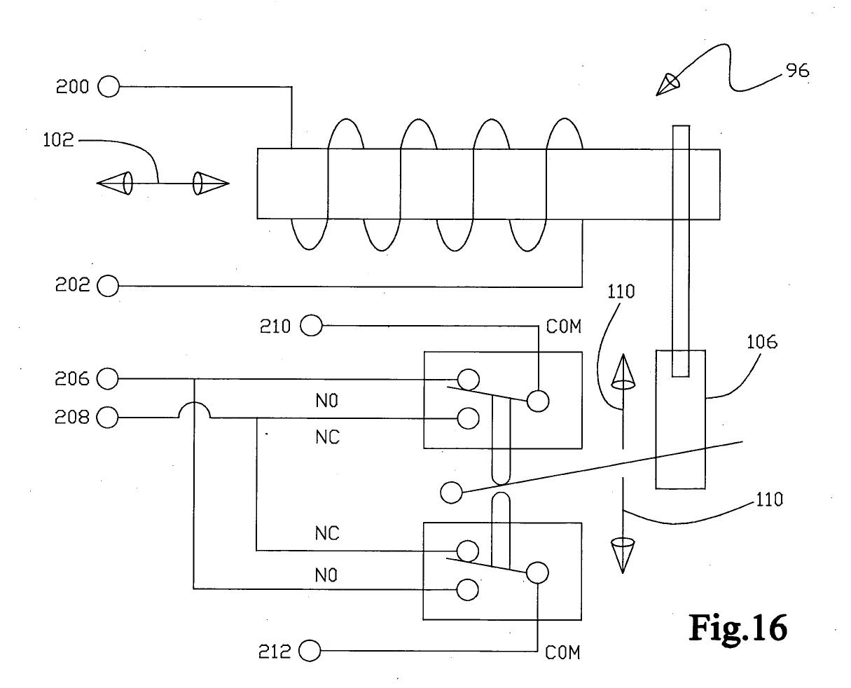

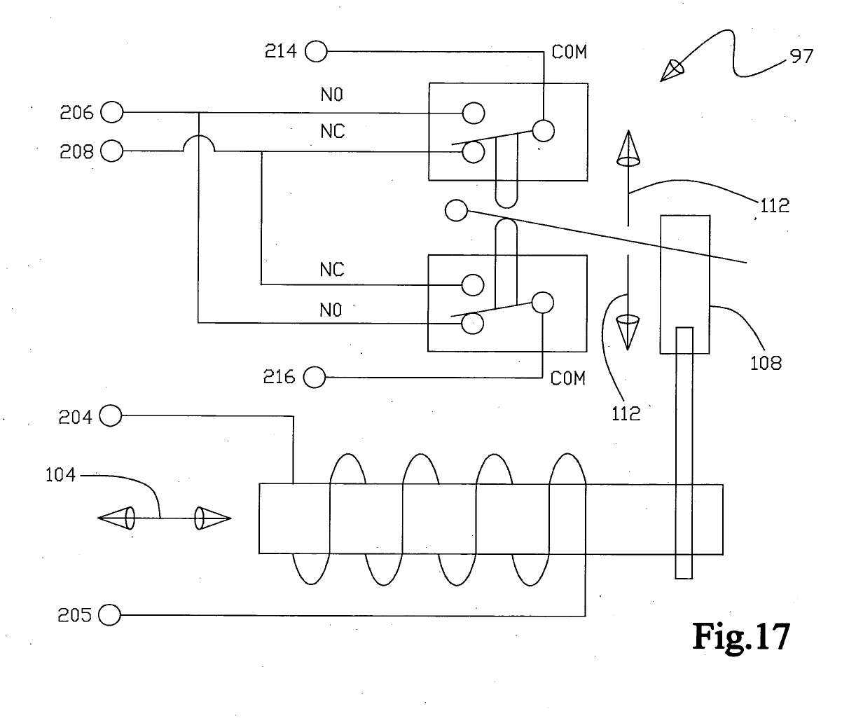

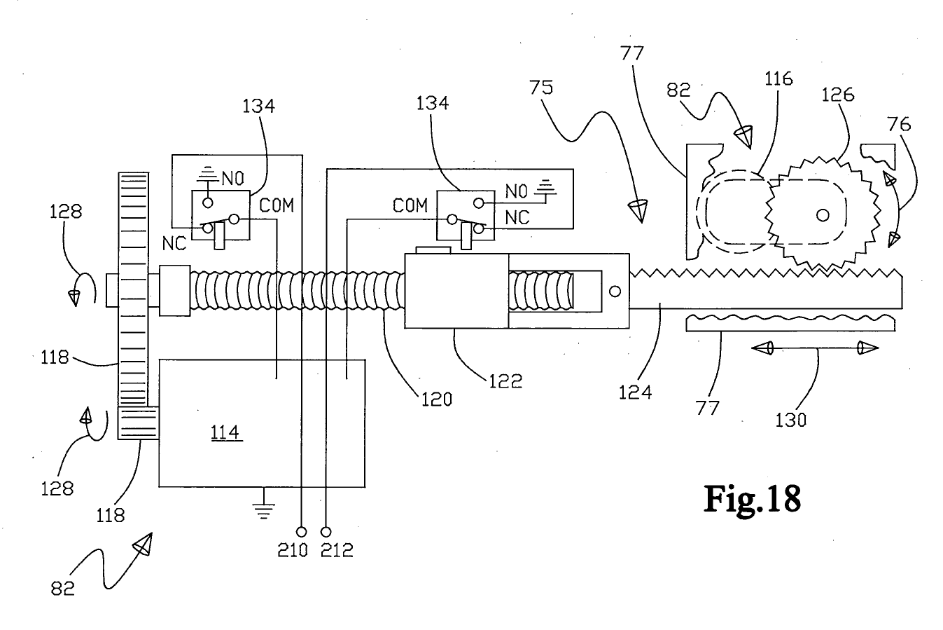

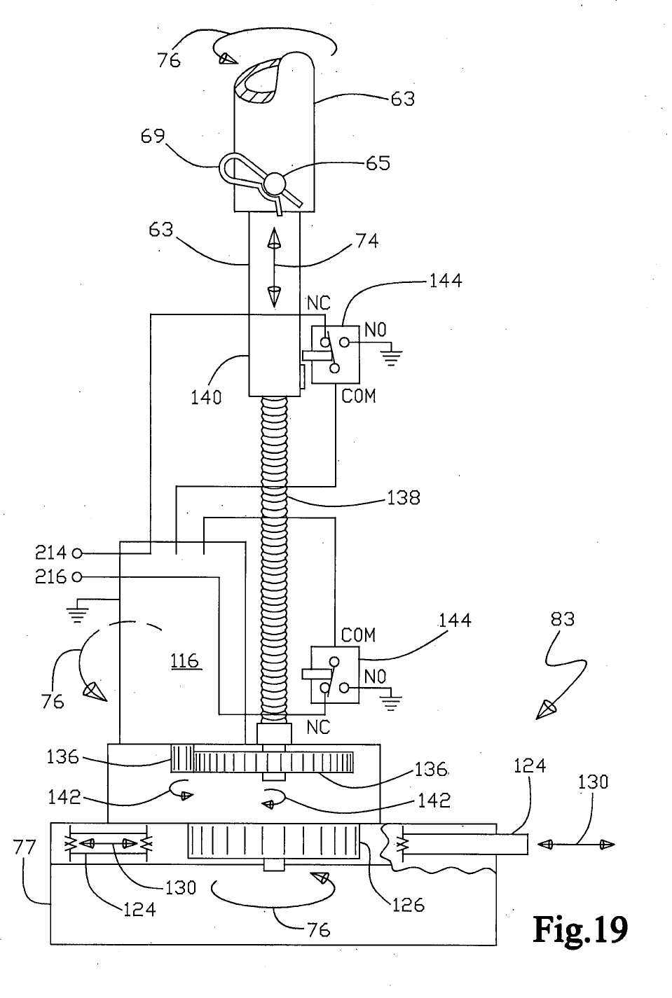

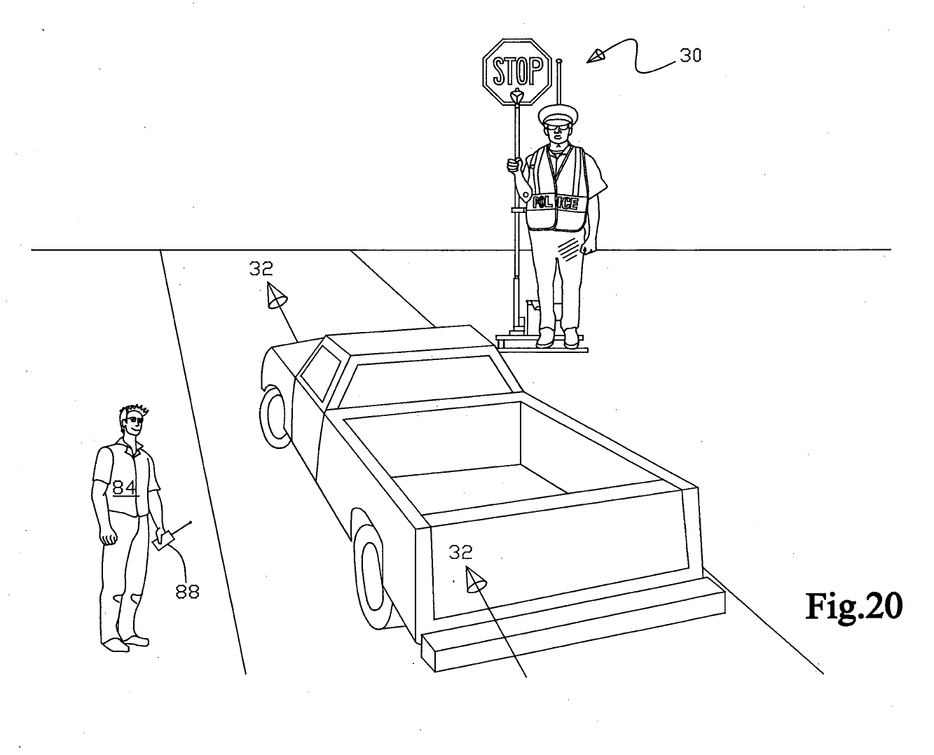

FIG. 11 shows an enlarged view of the control circuitry 80 and the circuitry housing 90. FIG. 12 shows a summary schematic of the means for creating a perceptible safety warning 64. FIGS. 13 through 15 show the mechanism for choosing a user selected warning 86. FIGS. 16 and 17 detail the first relay 96 and the second relay 97, respectively, while FIGS. 18 and 19 show detailed views of the first actuator 82 and the second actuator 83, respectively. Finally, FIG. 20 shows a use drawing of the traffic control apparatus 30 showing a user 84 utilizing a remote control 88 to control a flow of traffic 32 by choosing a user selected warning 86.

Broadly, in referring to FIGS. 1-6, the traffic control apparatus 30 comprises a base structure 34, a figurine 46 supported by a base structure 34 to help solicit attention from the flow of traffic 32, and a method for creating a perceptible safety warning 64 using a combination of the base structure 34 and the figurine 46. The base structure 34 of the preferred embodiment, enlarged in FIGS. 9-10, includes a base first portion 38 and a base second portion 40 disposed substantially adjacent to each other. As an additional feature, the base first portion 38 and the base second portion 40 are operationally capable of independent motion 42 and could act as a means for base flexibility. In the preferred embodiment, the base first portion 38 and the base second portion 40 would be composed of a metal alloy, such as carbon steel. The base first portion 38 and the base second portion 40 could be in the form of a C-shaped channel, with approximate dimensions of width of three (3) inches, height of one and eleven thirty-seconds (1 11/32) inches with a top channel height of approximately three-sixteenths ( 3/16) inches. In the preferred embodiment, the length of the first base portion 38 would be slightly greater than the length of the second base portion 40 to increase stability of the traffic control apparatus 30, with the base first portion 38 having a length of about twenty-seven (27) inches and the base second portion 40 having a length of about twenty-four (24) inches. The means for both controlling omnidirectional movement 44 and base flexibility 36 is preferably a resilient spring 45, preferably composed of heli-coiled one-quarter (¼) inch diameter steel rod coiled to a diameter of one and three-quarters (1¾) inches and rated for fifty (50) pounds per inch, is disposed between the base first portion 38 and the base second portion 40, as the method for independent motion 42 of base first portion 38 and base second portion 40. The spring 45 is preferably attached therebetween through welding. The spring 45 is treated to be weather resistant or, alternately, could be fully composed of a weather resistant material or could be something other than a spring that performs a like function. The spring 45 binds the base first portion 38 and the base second portion 40 such that base first portion 38 and base second portion 40 would be substantially parallel. As an option, more than one spring could be used to accomplish a similar result. The spring 45 aids in controlling omnidirectional movement 44 between the base first portion 38 and the base second portion 40, being operational to facilitate perceptibility of the figurine 46 and the method for creating a perceptible safety warning 64 by the flow of traffic 32 in adverse environmental conditions, such as thunderstorms, high winds, or earthquakes, and the like.

The figurine 46 is mounted to the base structure 34 by a support system 47, best visible in FIG. 5, which is adjacent to the second base portion 40. The support system 47 is preferably constructed from a light metal, such as aluminum, and partially could consist of an L-shaped metal plate, of approximately six (6) inches length and six (6) inches height, with a width of one quarter (¼) inch, which is affixed to the figurine 46 and the base structure 34 by screws or some similar means. The support system 47 could further comprise two (2) rods that extend from the base structure 34 to form an acute angle near the distal portion of the figurine 46 and are attached to a nylon plate located therebetween. The figurine 46 is preferably attached to the base structure 34 using a strong weather proof adhesive, but other means of attachment, such as screw and nut assemblies, are also plausible. The figurine 46 could further be sized and configured to substantially appear to be a highway flagman or a traffic safety officer 50 to the flow of traffic 32, thereby soliciting attention from the flow of traffic 48. In the preferred embodiment, the figurine 46 is composed of sheet metal cut in the shape of a life-sized human figure, but other materials and configurations would also be suitable. The figurine 46 is further fitted with an overlay of a life-sized photograph or otherwise embellished in such a way to substantially appear to be a highway flagman or traffic safety officer 50.

An optional feature for the figurine 46 would be to include a pivotal arm 52 adjacent 54 to the figurine 46 and the means for creating a perceptible safety warning 64, being operational to further add support between the base structure 34 and the means for creating a perceptible safety warning 64 and also to further solicit attention from the flow of traffic 32. The pivotal arm could be made out of a substantially similar material to the figurine 46, and could be attached through a variety of structures, such as a screw and nut assembly and the like. The pivotal arm 52 is foreseeably comprised of a plurality of elements pivotally connected to one another 56 through a similar means as the connection between the pivotal arm 52 and the figurine 46, including at least a proximal arm portion 58 and a distal arm portion 60. The pivotal elements are sized and configured to substantially resemble a human arm 62. The distal arm portion of the pivotal arm 60 or the arm of the figurine 46 is connected to a telescoping pole assembly 63 via a telescoping pole guide 67, wherein the telescoping pole guide 67 is preferably an omnidirectional nylon coupling to allow for the movement being rotational movement 76 and/or bidirectional movement 74 of the telescoping pole assembly 63. The distal arm portion 60 could be affixed to the telescoping pole guide 67 in such a way as to raise and lower the pivotal arm 52 along with the telescoping pole assembly 63, while allowing the telescoping pole assembly 63 to rotate freely within the telescoping pole guide 67. The telescoping pole assembly 63 is preferably made of a light metal, such as aluminum, which is substantially in the shape of a one (1) inch hollow cylinder and is useful for creating a perceptible safety warning 64. In addition to the telescoping pole guide 67 provided adjacent to the distal portion of the arm 60 of the figurine 46, another telescoping pole guide 67 could be added, which would extend from the support system 47 to add further strength to the telescoping pole assembly 63. The telescoping pole assembly 63 is assembled in the preferred embodiment by a pin 65 and lock ring 69, as illustrated in FIG. 8, and provides further support between the base structure 34 and the method for creating a perceptible safety warning 64.

The means 64 for creating a perceptible safety warning in the preferred embodiment includes a fastener 71, which in this particular embodiment consists of two pieces of metal with a width of about fifteen-sixteenths ( 15/16) inches, which are adjacently attached on either side of an octagonally shaped piece of lightweight metal, such as aluminum. The fastener 71, as attached to the octagonally shaped piece of metal in the preferred embodiment, extends out from it so as to fit into the hollow of the preferred telescoping pole assembly 63, and can be secured through a variety of ways such as a bolt. The octagonally shaped piece of metal is substantially sized to appear as a standard stop sign. The preferred embodiment of the means 64 for creating a perceptible safety warning includes an indicia indicating ‘STOP’ 66 on one side, configured so as to appear as a standard stop sign, and an indicia indicating ‘SLOW’ 68 on the reverse side, configured so as to appear as a standard slow sign. Various media including high visibility reflective tape could be utilized to create the indicia indicating ‘STOP’ 66 and the indicia indicating ‘SLOW’ 68. In the future, it could further be foreseeable for both the ‘STOP’ indicia 66 and the ‘SLOW’ indicia 68 to be on a single side of the sign, with the ability for the visual output of the sign to change between one indicia and another. In addition to the indicia 66, 67, the traffic control apparatus 30 could further include a mechanism 78 and structure to create bidirectional movement of the indicia 74 or rotational movement of the indicia 76 to further solicit attention from the flow of traffic 32. These operational states of bidirectional movement state 74 and rotational movement state 76 could be selectively operated either individually or simultaneously by the user through a remote control 88.

Another option for further conspicuousness of the traffic control apparatus 30 to the flow of traffic 32 of the means 64 for creating a perceptible safety warning would be to add illumination. Preferably and as shown in FIG. 7, a red strobe light 72 is adjacent to the indicia indicating ‘STOP’ 66. As shown in FIG. 2, a yellow strobe light 70 is adjacent to the indicia indicating ‘SLOW’ 68. The red strobe light 72 and yellow strobe light 70 could be battery operated light emitting diodes, and could be configured to screw onto the perceptible safety warning 64, or attached through a variety of similar means. The illumination could be continuous or periodic.

Further, in more detail the means 64 for creating a perceptible safety warning preferably includes a mechanism 78 that is preferably located adjacent to the base structure 34 and is best illustrated in FIGS. 9-10. The mechanism 78 could control different operational states of the traffic control apparatus 30, such as bidirectional movement state of the indicia 74. The mechanism could further control an operational state to include rotational movement state of the indicia 76, either instead of or in addition to the bidirectional movement 74. In the preferred embodiment, the mechanism 78 includes control circuitry 80 that is enclosed within a housing 90 which is composed of a weather resistant material and is attached to the figurine 46 with screws, or another similar means of attachment, as shown in FIG. 11. The power supply 94 is also encased within a weather resistant housing 92 and is in electrical communication with a first relay 96, a second relay 97, and a two channel receiving unit 98. The power supply 94 of the preferred embodiment is a 12 Volt marine battery, though other forms of power could be utilized. A summary schematic of the circuitry is shown in FIG. 12.

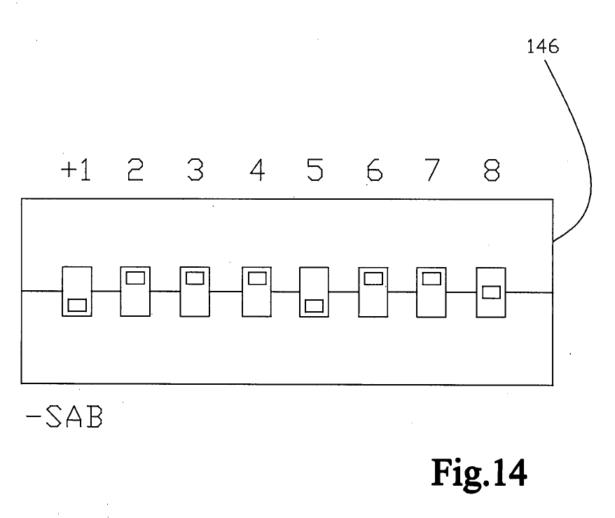

The mechanism 78 is alternatively operational by a user 84 via remote control 88, such as Albano Elettronica model number TX Trinary B-5 or its equivalent, and further enhances perceptibility by the flow of traffic 32 of a user selected warning 86. The remote control 88 further promotes safety of the user 84 being distanced from the flow of traffic 32. The remote control 88 would preferably include an indicator light 148 to alert a user 84 if the batteries are in need of replacement, a button 150 for control of a first relay 96 and a button 152 for control of a second relay 97 or vice versa. The remote control 88 further includes an internal dip switch 146 to set the channel frequencies for the unit's radio transmission. The mechanism 78 also includes control circuitry 80 and one or more actuators 82, as indicated above, and as illustrated in FIGS. 11-19. In its preferred embodiment, the control circuitry 80 is comprised of an antenna 100 in communication with a two channel receiving unit 98 for the reception and interpretation of the signal from the remote control 88, which is shown in FIG. 13. The two channel receiving unit 98 utilized in the preferred embodiment is a 12 Volt direct current/24 Volt alternating current Albano Elettronica model number AE/RX-Trinary-5, with a frequency of 26.995 mega-Hertz or any similar alternative. The preferred two channel receiving unit 98 is further equipped with a dip switch 146 to match the channel frequencies set in the remote control 88 to allow wireless communication between the two channel receiving unit 98 and the remote control 88. FIG. 14 shows the dip switch with its exemplary settings.

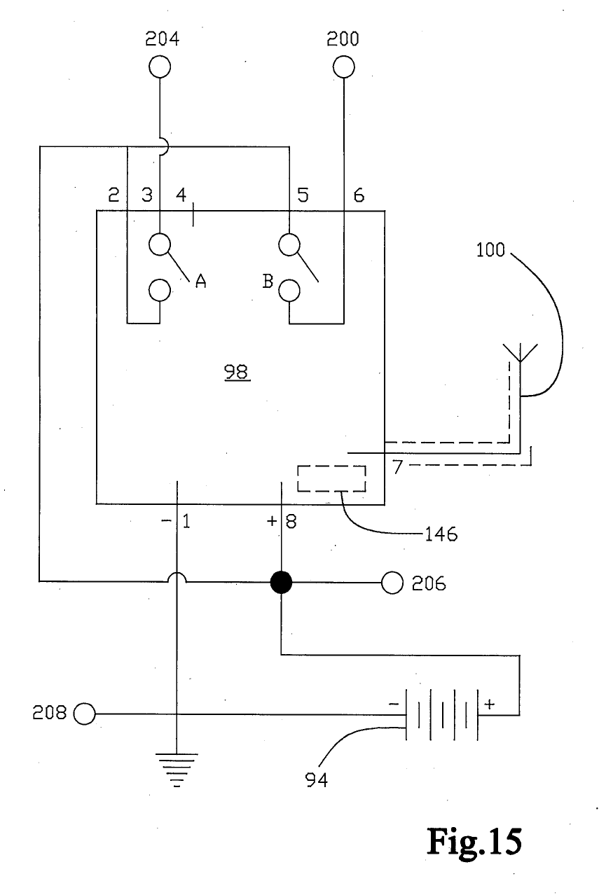

Direct positive power 206 for the mechanism 78 runs through the two channel receiving unit 98 from the power supply 94 and further through a terminal block 208 which is in electrical communication with the power supply 94 negative ground. The terminal block 208 used in the preferred embodiment is composed of several of Phoenix Contact part number TYPD-QTC15-Quattro or equivalents. If the user selected warning 86 chosen by the user 84 is rotational motion of indicia 76, the two channel receiving unit 98 will run switched power 200 for the first relay 96. If the user selected warning 86 chosen by the user 84 is bidirectional movement of the indicia 74, the two channel receiving unit 98 will run switched power 204 for the second relay 97. The two channel receiving unit is shown in detail in FIG. 15.

The mechanism for creating a perceptible safety warning further could include a plurality of relays 96, 97 and a plurality of actuators 82, 83, in addition to a remote control 88 and a power supply 94, all disposed adjacent to the base structure 34. The first relay 96 is shown in detail in FIG. 16, and is preferably a Potter and Brumfield model number S89R11AAC 1-24, which is rated for a voltage of 24 Volts and a frequency of 50-60 Hertz, or its equivalent. The switched power 200 for the first relay 96 causes movement 102 of the first relay 96 and produces movement of the com 106 for the first relay to further cause alternating movement of the first relay 110. The switched power for the first relay 200 terminates at the ground for the first relay 202. The alternating movement 110 of the first relay 96 causes a reversal of the communication pathways for the direct positive power 206 and terminal block 208 as negative power as electrical communication continues through the motor power leads for rack and pinion 210, 212, thus enabling reversal of motor 114 rotation 128 allowing for movement 130 ultimately resulting in rotational movement 76 state with all movement being bidirectional.

The first relay 96 portion of the mechanism 78 is further in electrical communication with a motor driven threaded rod 120 adjacent to a gear rack 124 having limit switch 134 controlled reciprocative movement 130 that is engaged to a gear pinion 126 that has rotational motion that operationally enables rotational motion of indicia 76. The reversal of magnetic polarity by the alternating movement 110 of the first relay 96 causes a motor for rack and pinion for stop/slow indicia change 114 to reverse its direction, which in turn reverses the bidirectional rotational movement 128 of the gear drive 118 for motor 114. The motor 114 of the preferred embodiment is FirgelliAuto part number ZYCJ(S) 01-40-12-3″ (5:1) or its equivalent. The gear drive 118 for motor 114 is further fitted with a square thread rod 120 that has been threaded with a drive block 122. The square thread rod 120 of the preferred embodiment has an inner diameter of about eleven thirty-seconds ( 11/32) inches, while the outer thread diameter measures about fifteen thirty-seconds ( 15/32) inches. As the gear drive 118 rotates, it forces the drive block 122 up the square thread rod 120. The drive block 122 for the square thread rod 120 is attached to a gear rack 124. The gear rack 124 is matably engaged with a gear pinion 126, which rotates with the reciprocating movement 130 of the gear rack 124. The rotation of the gear pinion 126 allows for rotational motion of indicia 76 and further causes rotational movement 76 of a second actuator 83. Preferably, the gear rack 124 would measure about three eighths (⅜) inch in width by about three eighths (⅜) inch in height by about six (6) inches in length, while the gear pinion 126 is set directly below and engaged further with the telescoping pole assembly 63. The teeth on the preferred gear rack 126 measure about one sixteenth ( 1/16) of an inch across and go to a depth of approximately one tenth ( 1/10) of an inch. The gear pinion 126 and the portion of the gear rack 124 which matably engages therewith the gear pinion are further enclosed in a rack and pinion housing 77, preferably composed of nylon and aluminum pieces in such a way as to be capable of supporting the second actuator 83. This first actuator 82 would be disposed substantially parallel to the base structure 34. Limit switches 134 are utilized for reciprocating movement of the gear rack 124 located along the path of the drive block 122 on the square thread rod 120 to ensure the proper approximately one hundred and eighty degree rotation of the indicia indicating ‘STOP’ 66 and the indicia indicating ‘SLOW’ 68. In the preferred embodiment, the limit switches are Suresold part number M4-A10-03 or its equivalent. FIG. 18 shows a detailed schematic of the first actuator 82 and the rack and pinion mechanism 75 and its mating actuator motor 116.

Movement bidirectionally of the indicia 74 would further add to the means 64 for creating a perceptible safety warning and mechanism 78 and is best shown in FIGS. 3-4. In the preferred embodiment, the second relay 97 and second actuator 83 control movement in a bidirectional state of the indicia 74. The second relay 97 is shown in detail in FIG. 17, and could be of the same make and model as the first relay 96, such as Potter and Brumfield's model number S89R11AAC 1-24, which is rated for a voltage of 24 Volts and a frequency of 50-60 Hertz, or its equivalent. The switched power 204 for the second relay 97 causes movement 104 of the second relay 97 and produces movement of the com 108 for the second relay 97 to further cause alternating movement 112 of the second relay 97. The switched power 204 for the second relay 97 terminates at the ground 205 for the second relay 97. The alternating movement 112 of the second relay 97 causes a reversal of the communication pathways for the direct positive power 206 and terminal block 208 negative power as communication continues through the motor 116 power leads 214, 216 for a square thread rod 138 for motor 116. The reversal of magnetic polarity causes the motor 116 for square thread rod 138 for rotational movement 142 bidirectionally of the indicia 74 to reverse its direction, which in turn reverses the bidirectional rotational movement 142 of the gear drive 136 for motor 116.

FIG. 19 shows a detailed schematic of the second actuator 83. The second actuator 83 portion of the mechanism 78 includes a motor 116 driven threaded rod 138 having limit switch 144 controlled movement that operationally enables bidirectional movement of an indicia 74. The motor 116 for the second actuator 83 of the preferred embodiment is substantially the same as the motor 114 for the first actuator 82, differing only in length of the attached square thread rod 138, such as FirgelliAuto part number ZYCJ(S) 01-40-12-12″ (5:1) or its equivalent. The gear drive 136 for motor 116 is fitted with a square thread rod 138 that has been threaded with a drive block 140. The square thread rod 138 of the preferred embodiment has an inner diameter of about eleven thirty-seconds ( 11/32) inches, while the outer thread diameter measures about fifteen thirty-seconds ( 15/32) inches. As the gear drive 136 rotates, it forces the drive block 140 up 74 the square thread rod 138. The drive block 140 for square thread rod 138 is attached to the telescoping pole assembly 63, to effect linear movement bidirectionally of indicia 74. The second actuator 83 could be attached directly to the rack and pinion housing 77 by screws, though other means of attachment are foreseeable. The second actuator 82 would be disposed substantially perpendicular to the base structure 34. Two limit switches 144 are utilized for controlling the bidirectional movement of indicia 74. The limit switches are located along the path of the drive block 140 on the square thread rod 138 to ensure the proper height differentiation of the indicia indicating ‘STOP’ 66 and the indicia indicating ‘SLOW’ 68. In the preferred embodiment, the limit switches are Suresold part number M4-A10-03 or its equivalent.

The final figure, FIG. 20 shows the traffic control apparatus 30 in its preferred use. A user 84 utilizing the remote control 88 can choose a user selected warning 86 to control the operational state of the traffic control apparatus 30 to direct the flow of traffic 32 either for the rotational movement state 76 or the bidirectional state 74, either individually or simultaneously.

### CONCLUSION

Accordingly, the present invention of a traffic control apparatus has been described with some degree of particularity directed to the embodiment of the present invention. It should be appreciated, though, that the present invention is defined by the following claims construed in light of the prior art so modifications of the changes may be made to the exemplary embodiment of the present invention without departing from the inventive concepts contained therein.

1. A traffic control apparatus to further control a flow of traffic, comprising:
(a) a base structure;
(b) a figurine supported by said base structure, said figurine is operational to help solicit attention from the flow of traffic; and
(c) a means for creating a perceptible safety warning using a combination of said base structure and said figurine.

2. A traffic control apparatus according to claim 1, wherein said figurine is sized and configured to substantially appear to be a highway flag person or a traffic officer to the flow of traffic.

3. A traffic control apparatus according to claim 2, wherein said figurine further comprises a pivotal arm that is adjacent to said figurine and said means for creating a perceptible safety warning, being operational to further add support between said base structure and said means for creating a perceptible safety warning.

4. A traffic control apparatus according to claim 3, wherein said pivotal arm is comprised of a plurality of elements pivotally connected to one another.

5. A traffic control apparatus according to claim 4 wherein said pivotal elements are sized and configured to substantially resemble a human arm.

6. A traffic control apparatus according to claim 1 wherein said means for creating a perceptible safety warning includes an indicia indicating ‘STOP’ or ‘SLOW’.

7. A traffic control apparatus according to claim 6 wherein said means for creating a perceptible safety warning further includes a red strobe light adjacent to said ‘STOP’ indicia and a yellow strobe light adjacent to said ‘SLOW’ indicia.

8. A traffic control apparatus according to claim 6 wherein said means for creating a perceptible safety warning includes structure to create movement bidirectionally of said indicia, to further solicit attention from the flow of traffic.

9. A traffic control apparatus according to claim 6 wherein said means for creating a perceptible safety warning includes structure to create rotational motion of said indicia, to further solicit attention from the flow of traffic.

10. A traffic control apparatus according to claim 1 wherein said base structure includes a base first portion and a base second portion disposed adjacent to each other, said base first portion and said base second portion are operationally capable of independent motion to one another.

11. A traffic control apparatus according to claim 10 wherein said base structure further comprises a means for controlling omnidirectional movement between said base first portion and said base second portion, being operational to facilitate perceptibility of said figurine and said means for creating a perceptible safety warning by the flow of traffic in adverse environmental conditions.

12. A traffic control apparatus according to claim 11 wherein said means for omnidirectional movement is a spring.

13. A traffic control apparatus to further control a flow of traffic, comprising:
(a) a base structure;
(b) a figurine supported by said base structure, said figurine is operational to help solicit attention from the flow of traffic; and
(c) a mechanism for creating a perceptible safety warning, said mechanism including control circuitry and an actuator that is disposed adjacent to said base structure, said mechanism is operational to further solicit attention from the flow of traffic by a user of said traffic control apparatus selecting an operational state of said traffic control apparatus.

14. A traffic control apparatus according to claim 13 wherein said mechanism is activated by the user through a remote control.

15. A traffic control apparatus according to claim 13 wherein said mechanism is enclosed within a plurality of housings.

16. A traffic control apparatus according to claim 13 wherein said mechanism further includes a power supply, a plurality of relays, a control, and a plurality of actuators.

17. A traffic control apparatus according to claim 13 wherein said mechanism includes indicia indicating ‘STOP’ adjacent to a red strobe light or indicia indicating ‘SLOW’ adjacent to a yellow strobe light.

18. A traffic control apparatus according to claim 17 wherein said mechanism includes a combination of movements of said indicia in a bidirectional operational state and a rotational operational state either individually of simultaneously that are selectively operated by the user through a remote control.

19. A traffic control apparatus according to claim 18 wherein said mechanism includes a motor driven threaded rod adjacent to a gear rack having limit switch controlled reciprocative movement that is engaged to a gear pinion that has rotational motion that operationally enables said rotational operational state.

20. A traffic control apparatus according to claim 18 wherein said mechanism includes a motor driven threaded rod having limit switch reciprocative movement that operationally enables said bidirectional operational state.

21. A traffic control apparatus to further control a flow of traffic, comprising:
(a) a base structure, including a base first portion and a base second portion disposed adjacent to each other and further including a spring, being operational to control omnidirectional movement between said base first portion and said base second portion;
(b) a figurine sized and configured to substantially appear to be a highway flag person or a traffic officer supported by said base second portion, further including a pivotal arm adjacent to said figurine, said figurine being operational to further solicit attention from the flow of traffic; and
(c) a mechanism including control circuitry comprising a power supply, a plurality of relays, a control, and a plurality of relays, all disposed adjacent to said base structure and being operational to create a perceptible safety warning, said perceptible safety warning including an indicia indicating ‘STOP’ adjacent to a red strobe light or an indicia indicating ‘SLOW’ adjacent to a yellow strobe light, said perceptible safety warning further including a combination of movements of said indicia in a bidirectional state and in a rotational state that are individually or simultaneously operated.
